(19) United States
(12) Patent Application Publication
(10) Pub. No.: US 2023/0129123 A1
(43) Pub. Date: Apr. 27, 2023

(54) Monitoring and Management System for Automatically Generating an Issue Prediction for a Trouble Ticket

(71) Applicant: Dell Products L.P., Round Rock, TX (US)

(72) Inventor: Dale Wang, Hayward, CA (US)

(73) Assignee: Dell Products L.P., Round Rock, TX (US)

(21) Appl. No.: 17/511,312

(22) Filed: Oct. 26, 2021

(51) Int. Cl. G06Q 10/06; G06Q 10/10

(52) U.S. Cl. CPC G06Q 10/06316; G06Q 10/10

(57) ABSTRACT

A method, system and/or computer usable program product for automatically providing an issue prediction to an IT (information technology) issue including receiving a trouble ticket regarding the IT issue, the trouble ticket including information identifying a categorized set of symptoms of the IT issue and identifying a set of IT assets impacted by the symptoms; utilizing the categorized set of symptoms and identified set of IT assets to query a trouble ticket system model for an automated issue prediction, the issue prediction including a predicted case classification based on case classifications of prior resolved trouble tickets with associated symptoms and IT assets corresponding to the trouble ticket symptoms and IT assets; and utilizing the predicted case classification to resolve the trouble ticket.

### BACKGROUND

### Technical Field

The present invention relates generally to information handling systems. More specifically, embodiments of the invention relate to a computer implemented method for automatically generating an issue prediction for a trouble ticket in an IT (information technology) system monitoring and management operation.

### Description of Related Art

As the value and use of information continues to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. These variations allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems, also referred to herein as data processing systems, are becoming increasingly complex and may span multiple software programs implemented across multiple hardware systems and networks, including implementations in one or more local data centers, a cloud environment, or a hybrid of local data centers and a cloud environment. As such information handling systems become increasingly more complex, so does the complexity in servicing and maintaining these systems, including the hardware and software contained in those systems. These complex information handling systems may be provided, in whole or in part, by Information Technology (IT) vendors for customers. That is, an IT vendor may provide an infrastructure of stacks of hardware and software configured as an information handling system for a customer in accordance with specifications for the configuration and/or capabilities of the system. Another IT vendor may provide software, a suite of software, or other products implemented as part of the underlying information handling system. In either case, the IT vendors may also provide maintenance of the system or specific products implemented as part of the system through ongoing maintenance agreements. Alternatively, the IT vendors may provide, in whole or part, a configured information handling system, specific products implemented as part of the system, and associated services of that system and specific products to one or more customers through Service Level Agreements (SLAs), thereby pushing the management and operation of the configured information handling system and/or the specific products from the customer to the IT vendor. This alternative approach may be useful in cloud or hybrid based information handling systems, such as where an IT vendor provides information handling systems or software products for multiple customers concurrently.

Maintenance of these information handling systems by IT vendors for one or more customers includes both ongoing regular maintenance and fixing identified IT issues such as when certain software and/or hardware is not performing as expected. Ongoing regular maintenance may include replacing certain hardware at predefined intervals and upgrading software such as when that software has a new version ready for implementing. Identified IT issues needing servicing may include a hard drive failing, software providing improper results or crashing, networks failing to communicate at times, etc. Each of the identified IT issues may be documented in a trouble ticket (also referred to herein as a service request or a support ticket). A trouble ticket may be generated by a representative (e.g., an employee) of a customer in response to an IT issue identified in the information handling system, by a representative of the IT vendor, automatically by the information handling system, etc. This trouble ticket may include a unique identifier of that trouble ticket for tracking and audit purposes, a timestamp when the trouble ticket was submitted, an identifier of the originator of the trouble ticket (customer, IT vendor, etc.), a description of the identified IT issue, identification of the user(s), hardware, software and/or networks which may be impacted by the identified IT issue, etc. Upon submission, the trouble ticket is assigned to trained agent(s) of the IT vendor, referred to herein as an IT agent, to determine the cause of the identified IT issue and resolve/correct that issue as soon as practical. The trained IT agent then reads the trouble ticket and then investigate the possible underlying issue type and root cause of the identified IT issue. This can include investigating the log files and telemetry of the identified user(s), hardware, software and/or networks as well as investigating log files and telemetry of associated IT assets in order to determine the issue type and root cause of the identified IT issue. Once the issue type and root cause have been determined, the trained agent then takes corrective action, also referred to herein as remediation, to resolve the determined issue type and root cause of the identified IT issues. The corrective action may then be tested prior to implementation. Upon implementation and possible confirmation that the identified IT issue has been resolved, the trouble ticket may then be closed by the trained IT agent of the IT vendor.

### SUMMARY

The illustrative embodiments of the present invention provide a method, system, and/or computer usable program product for automatically providing an issue prediction to an IT (information technology) issue including receiving a trouble ticket regarding the IT issue, the trouble ticket including information identifying a categorized set of symptoms of the IT issue and identifying a set of IT assets impacted by the symptoms; utilizing the categorized set of symptoms and identified set of IT assets to query a trouble ticket system model for an automated issue prediction, the issue prediction including a predicted case classification based on case classifications of prior resolved trouble tickets with associated symptoms and IT assets corresponding to the trouble ticket symptoms and IT assets; and utilizing the predicted case classification to resolve the trouble ticket.

### BRIEF DESCRIPTION OF THE DRAWINGS

The novel features believed characteristic of the invention are set forth in the appended claims. The present invention may be better understood, and its numerous objects, features and advantages made apparent to those skilled in the art by referencing the accompanying drawings. The use of the same reference number throughout the several figures may designate a like or similar element.

FIG. 1 provides a high level block diagram of illustrative network of data processing systems supported by an IT vendor in which various embodiments of the present disclosure may be implemented;

FIG. 2 provides a high level flow diagram of a trouble ticket being processed, in which various embodiments of the present disclosure may be implemented;

FIG. 3 provides block diagram of a trouble ticket management system in which various embodiments of the present disclosure may be implemented;

FIG. 4 provides examples of troubleshooting session events associated with captured data types by the trouble ticket management system, in which various embodiments may be implemented;

FIGS. 5A-5B provide flow diagrams of trouble tickets being processed, in which various embodiments of the present disclosure may be implemented;

FIG. 6 provides a block diagram of an illustrative data processing system in which various embodiments of the present disclosure may be implemented; and

FIG. 7 provides a block diagram of an illustrative network of data processing systems in which various embodiments of the present disclosure may be implemented.

### DETAILED DESCRIPTION

Processes and devices may be implemented and utilized for automatically generating an issue prediction for a trouble ticket in an IT system monitoring and management operation. These processes and apparatuses may be implemented and utilized as will be explained with reference to the various embodiments below.

In the present embodiment, a model is developed for predicting an issue underlying a trouble ticket. This predictive model may be developed by automatically monitoring the actions of an IT agent resolving previously submitted trouble tickets describing symptoms and affected IT assets. These IT agent actions may be recorded as session events and as associated log data lines accessed by the IT during these session events. Upon the resolution of a trouble ticket, the IT agent may then classify the underlying event type and root cause, collectively referred to as a case classification, upon closing the trouble tickets. A supervisory model may be developed from the closed trouble tickets by aggregating the session events based on correlations set forth in predetermined criteria, filtering the session events based on associated log data lines, and developing labeled data as described below. This labeled data may then be utilized through statistical analysis and pattern recognition, such as supervised machine learning, to develop a predictive model. Once developed, tested and implemented, this predictive model may then be utilized to predict the event type and root cause for a newly submitted trouble ticket based on symptoms and IT assets affected thereby.

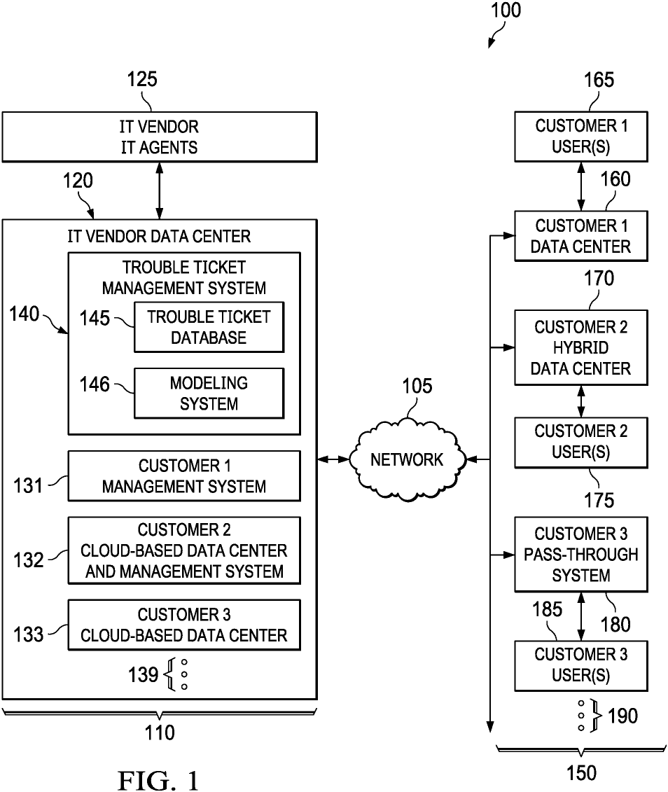

FIG. 1 provides a high level block diagram of an illustrative network of data processing systems supported by an IT vendor in which various embodiments of the present disclosure may be implemented. Data processing systems 100 is one example of a suitable network of data processing systems and is not intended to suggest any limitation as to the scope of use or functionality of the embodiments described herein. Regardless, data processing systems 100 is capable of being implemented and/or performing any of the functionality set forth herein such as automatically generating an issue prediction for a trouble ticket in an IT system monitoring and management operation. Trouble ticket issue prediction may include providing an issue prediction including an issue type and a root cause, collectively referred to herein as a case classification, of the trouble ticket IT issue. Trouble ticket issue prediction may also include providing access to prior efforts to remediate that issue prediction. An issue type may be selected from a predefined set of issue type classifications generally describing an IT issue prompting the submission of a trouble ticket. A root cause may be a factor that caused a nonconformance or other undesirable result which may be resolved through a process or product improvement and may be selected from a predefined set of root cause classifications. A resolution to the root cause may include determining that the cause of the trouble ticket issue (also referred to as a trouble ticket issue herein) was human error which may be resolved with some training or it may include determining a technical issue necessitating an IT based solution (i.e., remediation). A resolution may include remediation, which includes taking some action, such as making some modifications or corrections, to some IT assets. For example, remediation may include replacing a hardware IT asset, upgrading some software to a newer version, correcting a software bug, modifying some IT configuration parameters, or other changes to some IT assets.

Data processing systems 100, also referred to herein as information handling systems (IHSs) 100, may include an IT vendor system 110 supporting customer data centers 150 across network 105. Customer systems may be generally classified into standalone systems with standalone data centers, cloud-based systems with pass-through data centers accessing remote cloud-based data centers, or a combination thereof referred to herein as hybrid systems with hybrid data centers interacting with cloud-based data centers . IT vendor data center 120 may support customer 1 standalone data center 160, customer 2 hybrid data center 170, customer 3 pass-through system 180 (although it may not strictly be a localized data center per se, such a pass-through network is also referred to herein as a type of data center), as well as other customers and other types of customer systems 190 across network 105. IT vendor data center may be accessed and supported by IT agents 115. IT agents 115 may be users that work for an IT vendor, either as employees or contractors. IT agents 115 may support the operations of IT vendor data center 110 and the customers of the IT vendor, including the data centers 150 of those customers. IT agents 115 also manage trouble tickets on behalf of the IT vendor system 110 and customer data centers 150. As such, IT agents typically have technical expertise sufficient to perform tasks for the IT vendor or IT customer such as investigating and resolving trouble tickets.

IT vendor data center 120 may include customer 1 monitoring system 131, customer 2 cloud-based data center and monitoring system 132, customer 3 cloud-based data center 133 as well as other customer data centers and monitoring systems 139. Customer 1 management system 131 may be utilized to manage customer 1 standalone data center 160 on behalf of customer 1 and its user(s) 165, including trouble tickets related to data center 160. That is, in the present embodiment, customer 1 has standalone data center 160 on the premises of customer 1, but the IT vendor provides support for that standalone data center remotely, including handling trouble tickets related to that standalone data center. This support may be for the whole standalone data center or portions thereof such as particular software, hardware, networks, etc. Customer 2 cloud-based data center and management system 132 may be utilized to manage customer 2 hybrid data center 170 as well as provide cloud-based data processing systems on behalf of customer 2 and its user(s) 175, including handling trouble tickets related thereto. That is, in the present embodiment, customer 2 has a data center 170 on the premises of customer 2, but also receives cloud-based data processing systems from the IT vendor. The IT vendor may provide support for both customer 2 data center 170 as well as customer 2 data center 132, including handling trouble tickets related to those data centers. This support may be for the whole data centers or portions thereof such as particular software, hardware, networks, etc. Customer 3 cloud-based data center 133 may be utilized to manage customer 3 pass-through system 180 as well as provide cloud-based data processing systems on behalf of customer 3 and its user(s) 185, including handling trouble tickets related thereto. That is, in the present embodiment, customer 3 receives cloud-based data processing systems from the IT vendor, but does not have a data center on the customer’s premises. The IT vendor may provide support for customer 3 cloud-based data center 133, including handling trouble tickets related to that data center. This support may be for the whole data centers or portions thereof such as particular software, hardware, networks, etc.

IT vendor data center 120 may also include a trouble ticket management system 140 including a trouble ticket database 145 and a modeling system 146. Trouble ticket management system 140 may be utilized by IT agents 125 to manage trouble tickets for IT vendor data center 120 and for customer data centers 150 on behalf of the IT vendor and its customers. In the present embodiment, trouble ticket database 145 may store trouble tickets from their submission through resolution and closing and subsequently for historical and modeling purposes. Modeling system 146 may utilize the trouble tickets stored in trouble ticket database 145 for modeling the process of resolving trouble tickets towards predicting the issue type and root cause of an IT issue described or otherwise identified in a trouble ticket. Greater detail of the trouble ticket management system components and operation is described below with reference to the below described Figures.

As can be appreciated by one skilled in the art, many other types of IT vendor and customer systems may be supported, including handling trouble tickets related thereto, with the various embodiments of the present disclosure. For example, the IT vendor may be a software provider that provides software support and handles related trouble tickets for a particular software product licensed to multiple customers across multiple systems, whether those customers are cloud-based, standalone based, or a hybrid thereof.

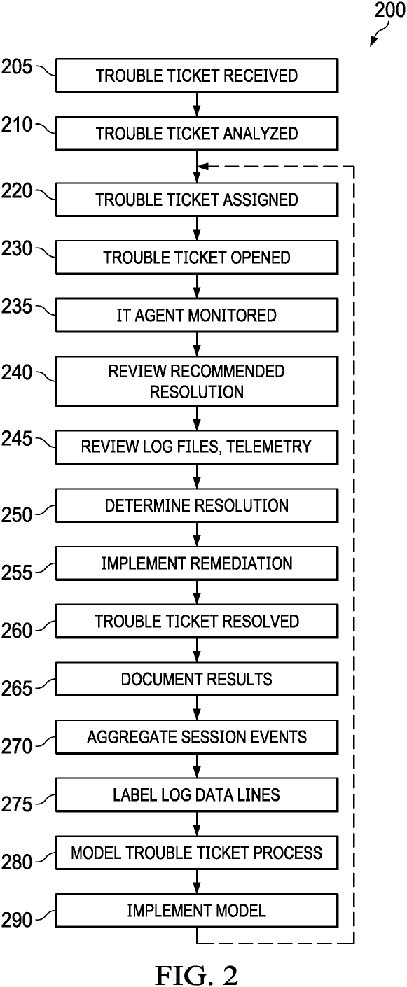

FIG. 2 provides a high level flow diagram 200 of a trouble ticket being processed, in which various embodiments of the present disclosure may be implemented. More particularly, FIG. 2 provides a high level flow diagram of a trouble ticket being processed towards developing an automated issue prediction for trouble tickets. FIG. 2 is described with reference to FIG. 1.

In a first step 205, a trouble ticket describing an IT (information technology) issue identified by a trouble ticket submitter is received by trouble ticket management system 140 and stored in a trouble ticket database 145. The IT issue may relate to a specific IT asset of data processing systems 100, a subsystem of the data processing systems, or across multiple subsystems of the data processing systems. If identified, the specific IT asset may be a specific piece of hardware, software, network or combination thereof. The subsystem may be a system of IT assets where a specific IT asset may not be identifiable by the submitter of the trouble ticket. The trouble ticket may also include other information such as a list of symptoms. This list of symptoms may be selected from a predefined set of categorized symptoms provided for selection by the trouble ticket submitter. Other types of information may be provided by the trouble ticket submitter in the trouble ticket. The trouble ticket may be submitted by a customer user of the data processing systems 160, 170 or 180, by an IT agent managing IT vendor data center 120 or customer data centers 150, by an IT agent managing trouble ticket management system 140 (perhaps when conversing with a user that is describing an IT issue), or it may be submitted automatically by the data process system or specific IT assets as an IT issue is detected by that system or asset. Until the trouble ticket has been resolved and closed, it may be referred to herein as an unresolved trouble ticket.

Optionally in a second step 210, the unresolved trouble ticket may be automatically assessed for identifying the relevant IT assets and symptom categories by trouble ticket management system 140. This analysis may include reviewing natural language analysis of the description of the IT issue. Based on this analysis, the trouble ticket may be assessed based on factors such as the description of the IT issue, the IT asset or subsystem mentioned, the location of the IT asset or subsystem, the identity of the trouble ticket submitter, etc. This automated assessment of relevant IT assets and symptom categories may be stored with or linked to the trouble ticket in trouble ticket database 145.

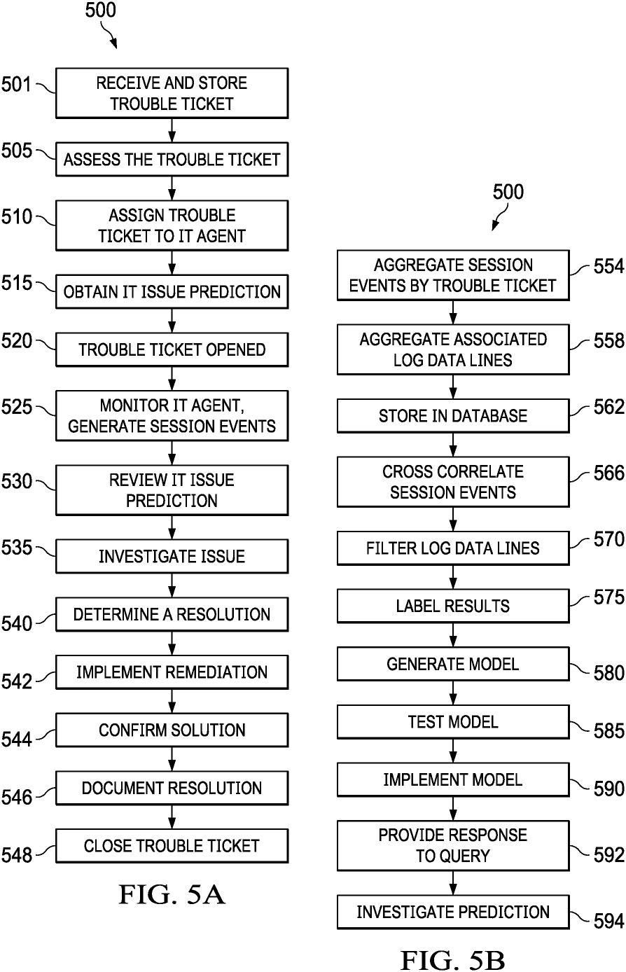

Then in step 220, the classified trouble ticket may be assigned to an IT agent. This assignment may be performed automatically by trouble ticket management system 140 or upon the direction of a person responsible for that assignment task. This assignment may be based on the trouble ticket IT issue, the relevant IT assets, the symptom categories, the experience and capabilities of the IT agent relative to the trouble ticket classification, the availability of the IT agent, etc. Additional IT agents may also be assigned if needed. As will be explained in further detail below with reference to FIG. 5, an issue prediction for the trouble ticket, including a predicted issue type and predicted root cause, may be provided to the assigned IT agent at this time. This issue prediction may be provided by a component of the trouble ticket management system or other system, such as described below. The issue prediction may include a predicted issue type and a predicted root cause identified from a predefined set of issue type and root cause classifications, which may be hierarchically organized. That is, a classification of issue types and root causes may be predefined by the IT vendor for utilization as described herein.

In step 230, the assigned IT agent may then open the unresolved trouble ticket from trouble ticket database 145 for determining the issue type and root cause of the IT issue described in that ticket towards providing any necessary remediation for resolving the open trouble ticket. Concurrently with opening the trouble ticket and until the IT agent’s trouble ticket session has ended or until the trouble ticket is closed, trouble ticket management system 140 may monitor the actions of the IT agent with regards to the open trouble ticket in step 235. This monitoring may include generating session events identifying the actions taken by the IT agent with regards to the trouble ticket as well as identifying the various types of data accessed by the IT agent.

Then in step 240, the assigned IT agent may review the issue prediction, if provided. As will be described below, there may not be an issue prediction provided until a sufficient number of similar trouble tickets have been processed. In step 245, the IT agent then utilizes a log viewer and other IT tools to access and review telemetry, log files, and other accessible data of IT assets that may be relevant to the IT issue (e.g., IT assets and symptoms) described in the assigned trouble ticket. This process may be driven in part by the issue prediction, if provided. This process will enable the IT agent to determine or confirm an issue type and root cause of the assigned trouble ticket.

In step 250, upon determining the issue type and root cause, the IT agent may determine an appropriate resolution, including any needed remediation, of the IT issue. In step 255, the IT agent may implement or cause to be implemented the appropriate remediation to resolve the determined issue type and root cause. This may be implemented after performing some tests to confirm that the remediation solves the issue type and root cause and does not create new IT issues. Then in step 260, the IT agent may confirm that the remediation resolves the IT issue and may confirm that the remediation does not create new IT issues. Then in step 265, the IT agent may then document the determined issue type and root cause as well as the remediation steps in the trouble ticket followed by closing the trouble ticket in trouble ticket database 145.

In step 270, the session events for the trouble ticket may be automatically aggregated by trouble ticket management system 140. That is, session events may be grouped together by trouble ticket. For example, multiple IT agents may work on a trouble ticket across multiple sessions utilizing multiple tools, thereby generating session events stored across multiple files and/or tables. By aggregating session events by trouble ticket, the analysis utilized for each trouble ticket may be more easily utilized such as automatically through modeling. In addition, aggregating session events may also allow for easier labeling for use in modeling the trouble ticket process. Data accessed with each session event, referred to herein as log data lines, may also be aggregated and associated with the session events that accessed those log data lines. Log data lines may come from log file, telemetry, etc. Step 270 may be performed concurrently with steps 230 through 265 or it may be performed upon the closing of the trouble ticket. Step 270 may be viewed as a pre-processing step for labeling in step 275 by enabling an efficient application of predetermined criteria.

Then in step 275, log data lines may be automatically labeled by trouble ticket management system 140 based on various predetermined criteria including cross-correlation of aggregated session events across multiple trouble tickets, filtering of associated log data lines accessed by an IT agent, etc. These predetermined criteria may be modified or supplemented by the IT vendor or other responsible persons or entities over time. In addition, predetermined criteria may be modified or supplemented through the use of various data mining tools utilized on the underlying trouble tickets, session events and labels.

In step 280, after a sufficient number of trouble tickets have been resolved and closed, the aggregated and labeled session events and log data lines may then be utilized for modeling the process of resolving trouble tickets in modeling system 146. Various types of modeling may be utilized including statistical analysis, machine learning and artificial intelligence, such as described in greater detail below. As shown with the bidirectional dashed line to step 220, modeling system 146 may then be utilized in step 290 towards predicting the issue type and root cause (i.e., case classification) of an IT issue described in subsequently submitted trouble tickets.

As will be apparent to those of ordinary skill in the art, many modifications and variations may be utilized towards implementing the trouble ticket resolution process of present disclosure. Additional details and embodiments are described below as examples of the scope and spirit of the present disclosure.

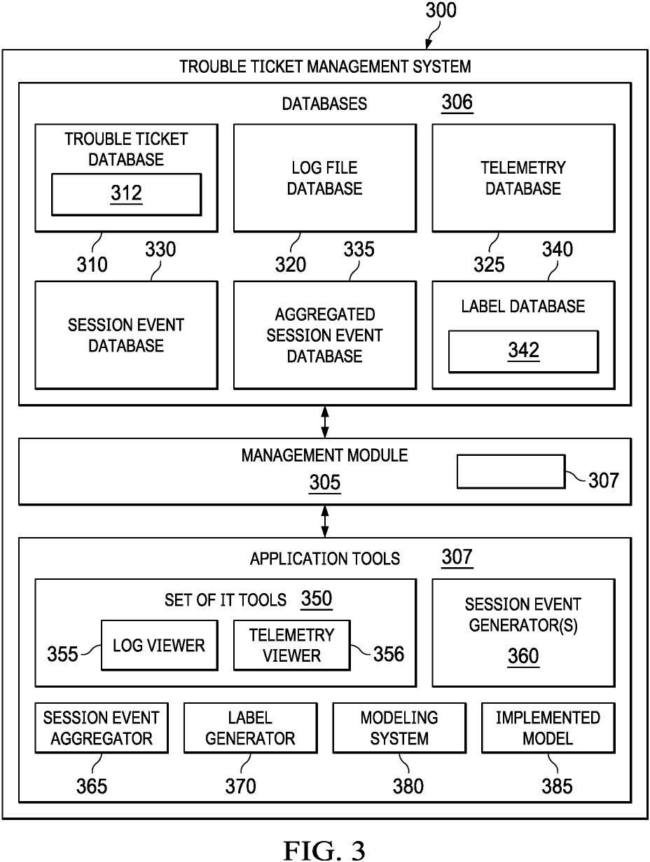

FIG. 3 illustrates a block diagram of a trouble ticket management system 300 in which various embodiments of the present disclosure may be implemented. Trouble ticket management system 300 may be a more detailed version of trouble ticket management system 140 described above. Trouble ticket management system 300 may include a management module 305 for managing operations of databases 306 and application tools 307. Databases 306 may include a trouble ticket database 310, a log file database 320, a telemetry database 325, a session event database 330, an aggregated session event database 335, and a label database 340. Application tools 307 may include a set of IT tools 350 including a log viewer 355 and a telemetry viewer 356, a session event generator 360, a session event aggregator 365, a label generator 370 utilizing predetermined criteria 342, a modeling system 380 and an implemented trouble ticket model 385. Trouble ticket management system 300 may be capable of being implemented and/or performing any of the functionality set forth herein such as automatically generating an issue prediction for a trouble ticket in an IT system monitoring and management operation.

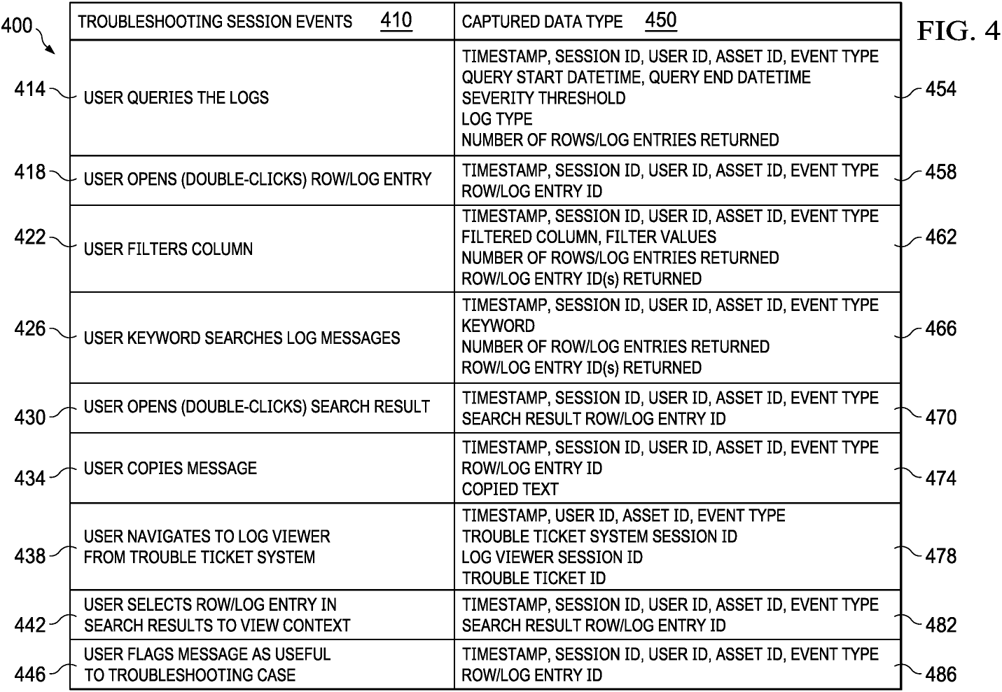

In addition to trouble ticket management module 305 managing the operation of the various components of trouble ticket management system 300 as described above, management module 305 may also perform certain operations such as classifying submitted trouble tickets and assigning certain unique identifiers. Management module 305 may also contain a predefined set of event type and root cause classifications which may be utilized for issue prediction as described below. An event type may be a hierarchically based description of the event type that has occurred (e.g., hard disk not providing requested data) and a root cause may be a hierarchically based description of a cause of the event type (e.g., hard disk spindle failure). The predefined set of event type and root cause classifications may be generated or modified by the IT vendor or other authorized entities or persons. Trouble ticket database 310 may store trouble tickets from their submission through resolution and closing and subsequently for historical and modeling purposes. These trouble tickets may have been submitted by customer users, IT agents or automatically by customer data centers or the IT data center. Trouble ticket database 310 may also include a predefined set of categorized symptoms 312 which may be modified by the IT vendor or other authorized entities or persons. Log file database 320 may contain log files for use in resolving trouble tickets or it may contain pointers to relevant log files that may be stored remotely. Log files are computer-generated data files that contain log data including information about usage patterns, activities, and operations within an operating system, application, server or another device. Alternatively, log file database may contain pointers to log files stored remotely. Telemetry database 325 may contain relevant telemetry for use in resolving trouble tickets or it may contain pointers to relevant telemetry that may be stored remotely. Telemetry is typically information about an IT asset’s configuration (i.e., operating system version, application program version, numbers of and type of central processing units, memory, hard drives, etc.), and health statistics such as performance, capacity, etc. Individual lines of log data files and telemetry files are referred to herein as log data lines. Session event database 330 may include session events generated by session event generator 360 based on monitoring IT agents investigating and resolving trouble tickets. Examples of types of session events are described below with reference to FIG. 4. Aggregated session event database 335 includes session events and associated log data and telemetry data accessed by the IT agents which has been indexed or otherwise grouped by trouble ticket. Alternatively, aggregated session events and associated log data and telemetry data (i.e., log data lines) could be indexed by trouble ticket with a pointer file. Label database 340 may include pointers to aggregated session events and associated log data and telemetry data across multiple trouble tickets. Alternatively, labeled session events could be stored in the database by type of trouble ticket (e.g., trouble ticket classification) such as by trouble ticket issue. Label database 340 may also include predetermined criteria 342 for labelling log data lines including cross-correlating aggregated session events across multiple trouble tickets and filtration of associated log data lines.

Set of IT tools 350 may include various IT tools that an IT agent may utilize to investigate and resolve trouble tickets. This may include log viewer 355 for viewing log files such as those stored in log file database 320. This may also include telemetry viewer 356 for viewing telemetry such as that stored in telemetry database 325. Session event generator(s) 360 may be a software tool for tracking and documenting the actions of an IT agent during an on-line session to investigate and resolve a trouble ticket. Session event generator(s) 360 may be limited to specific IT tools that an IT agent is utilizing and/or it may be more general and generate session events across or between the utilization of certain IT tools. Session event generator 360 generates session events, such as described below with reference to FIG. 4, based on the activities of the IT agent during on-line session. Session event aggregator 365 automatically aggregates session events by trouble ticket, including associated log data and telemetry data accessed during those session events, which may then utilized for labelling in accordance with predetermined criteria 342 as described herein. That is, multiple IT agents may work on a given trouble ticket across multiple sessions utilizing multiple tools, thereby generating session events and associated data stored across multiple files and/or tables in accordance with predetermined criteria 342. By automatically aggregating session events by trouble ticket, the analysis utilized for each trouble ticket may be more easily discerned automatically through modeling as described herein. Label generator 370 automatically labels aggregated session events and data across multiple trouble tickets for use in modeling utilizing predetermined criteria 342. Predetermined criteria 342 may be developed and modified by the IT vendor or other authorized entities or persons. Modeling system 380 utilizes the labeled aggregated session events to model the trouble ticket system. Implemented trouble ticket model 385 may be a model or set of models of the trouble ticket system that is utilized for providing an issue prediction for a trouble ticket.

As will be apparent to those of ordinary skill in the art, other types of data could be stored in trouble ticket management system 300 for use in modeling as described herein. In addition, other types of IT tools and other processing components may be utilized for generating and implementing a model as described herein. Utilization of the components of the trouble ticket management system is described below with reference to FIG. 5.

FIG. 4 provides examples 400 of troubleshooting session events 410 associated with captured data types 450 by the trouble ticket management system, in which various embodiments may be implemented. Troubleshooting session events 410 include multiple types of events or actions that may be taken by an IT agent utilizing various IT tools such as a log file viewer during an on-line session when investigating and resolving a trouble ticket. In the present embodiment, troubleshooting session events 410 may include user queries the logs 414, user opens (double-clicks) row/log entry 418, user filters column 422, user keyword searches log messages 426, user opens (double-clicks) search result 430, user copies message 434, user navigates to log viewer from trouble ticket system 438, user selects row/log entry in search result to view context 442, and user flags message as useful to troubleshooting case 448. Additional or different types of troubleshooting session events may be utilized in alternative embodiments to capture the same or different data types.

User queries the logs 414 may be utilized by the IT agent to capture log entries from a given log file based on various queries. Captured data types 454 may include a timestamp of when the IT agent make the query, a session ID (identifier) of the current IT agent session, a user ID which is a unique identifier of the IT agent, an asset ID identifying the IT asset associated with the log file, an event type identifying the type of action that the IT agent has performed to generate this session event, query start date time and query end date time capturing a date and time range utilized by the IT agent as a filter in the log query, severity threshold identifying the severity of log entries utilized by the IT agent as a filter in the log query, log type identifying the type of log file being queried, and number of rows/log entries returned as a result of the IT agent log query. A trouble ticket identifier could also be captured depending on the low viewer tool utilized by the IT agent and its capabilities.

User opens (double-clicks) row/log entry 418 may be utilized by the IT agent to capture or view a specific row or log entry in the log file being viewed. Captured data types 458 may include a timestamp of when the IT agent make the query, a session ID of the current IT agent session, a user ID which is a unique identifier of the IT agent, an asset ID identifying the IT asset associated with the log file, an event type identifying the type of action that the IT agent has performed to generate this session, and a row/log entry ID identifying the specific row or log entry captured by use of session event 418.

User filters column 422 may be utilized by the IT agent for filtering log entries of a log file to capture those with desired attributes. Captured data types 462 may include a timestamp of when the IT agent make the query, a session ID of the current IT agent session, a user ID which is a unique identifier of the IT agent, an asset ID identifying the IT asset associated with the log file, an event type identifying the type of action that the IT agent has performed to generate this session, a filtered column including a column of session events meeting the desired attributes, filter values including session event values meeting the desired attributes, number of rows/log entries returned including the number of rows or log entries meeting the desired attributes, and row/log entry ID(s) returned as a result of the IT agent filtration query.

User keyword searches log messages 426 may be utilized by the IT agent to capture or view log messages with certain keywords in the log file being searched. Captured data types 466 may include a timestamp of when the IT agent make the query, a session ID of the current IT agent session, a user ID which is a unique identifier of the IT agent, an asset ID identifying the IT asset associated with the log file, an event type identifying the type of action that the IT agent has performed to generate this session, a keyword identifying the keyword utilized by the IT agent as a filter in the message search, number of rows/log entries returned including the number of rows or log entries meeting the desired attributes, and a row/log entry ID(s) returned as a result of the IT agent keyword query.

User opens (double-clicks) search result 430 may be utilized by the IT agent to capture or view a specific log entry from the log file search results being viewed. Captured data types 470 may include a timestamp of when the IT agent make the query, a session ID of the current IT agent session, a user ID which is a unique identifier of the IT agent, an asset ID identifying the IT asset associated with the log file, an event type identifying the type of action that the IT agent has performed to generate this session, and a search result row/log entry ID identifying the session event clicked on by the IT agent.

User copies message 434 may be utilized by the IT agent to copy portions of a message in the log file being viewed. Captured data types 474 may include a timestamp of when the IT agent make the query, a session ID of the current IT agent session, a user ID which is a unique identifier of the IT agent, an asset ID identifying the IT asset associated with the log file, an event type identifying the type of action that the IT agent has performed to generate this session, a row/log entry ID(s) returned as a result of the IT agent message copying, and copied text including the text copied from the session event.

User navigates to Log Viewer from Trouble Ticket System 438 may be utilized by the IT agent to navigate from a log viewer back to the trouble ticket system. Captured data types 478 may include a timestamp of when the IT agent make the query, a session ID of the current IT agent session, a user ID which is a unique identifier of the IT agent, an asset ID identifying the IT asset associated with the log file, an event type identifying the type of action that the IT agent has performed to generate this session, Trouble Ticket System Session ID is a unique identifier of a IT agent’s session in investigating and resolving a trouble ticket, Log Viewer Session ID is a unique identifier of a log viewer being utilized by an IT agent, and trouble ticket ID is a unique identifier of a given trouble ticket being investigated and resolved by an IT agent.

User selects row/log entry in search result to view context 442 may be utilized by the IT agent to capture or view a specific row or log entry in the log file being viewed. Captured data types 482 may include a timestamp of when the IT agent make the query, a session ID of the current IT agent session, a user ID which is a unique identifier of the IT agent, an asset ID identifying the IT asset associated with the log file, an event type identifying the type of action that the IT agent has performed to generate this session, and a row/log entry ID(s) returned as a result of the IT agent search result.

User flags message as useful to troubleshooting case 446 may be utilized by the IT agent to flag a specific message within the log file being viewed. Captured data types 486 may include a timestamp of when the IT agent make the query, a session ID of the current IT agent session, a user ID which is a unique identifier of the IT agent, an asset ID identifying the IT asset associated with the log file, an event type identifying the type of action that the IT agent has performed to generate this session, and a and a row/log entry ID(s) returned as a result of the IT agent message flagging.

As will be apparent to those of ordinary skill in the art, additional types of session events may be captured during an on-line trouble ticket investigation and resolution session by an IT agent. Additional session events and different data types may be captured based on the IT environment and the IT tools being utilized by the IT agent. For example, if a log viewer is tightly coupled with an on-line trouble ticket management system, the trouble ticket ID may be captured with each of the session events, thereby reducing the processing needed to aggregate session events later.

FIGS. 5A-5B provide a flow diagram of trouble tickets being processed, in which various embodiments of the present disclosure may be implemented. More particularly, FIG. 5A provides a flow diagram 500 of a trouble ticket being processed by an IT agent towards developing an automated issue prediction of trouble tickets. FIG. 5B provides a flow diagram 550 of utilizing previously processed trouble tickets to develop an implemented trouble ticket model 385 which is then utilized to provide an automated issue prediction of a subsequently submitted trouble ticket. FIGS. 5A and 5B are described with reference to the other Figures herein.

In a first step 501 of FIG. 5A, a trouble ticket describing an IT (information technology) issue identified by a trouble ticket submitter is received by trouble ticket management system 300 and stored in a trouble ticket database 310 indexed with a unique trouble ticket identifier. The IT issue may relate to a specific IT asset of data processing systems 100, a subsystem of the data processing systems, or across multiple subsystems of the data processing systems. If identified, the specific IT asset may be a specific piece of hardware, software, network or combination thereof. The subsystem may be a system of IT assets where a specific IT asset may not be identifiable by the submitter of the trouble ticket. The trouble ticket may also include other information such as a list of symptoms. This list of symptoms may be selected from a predefined set of categorized symptoms provided for selection by the trouble ticket submitter. Other types of information may be provided by the trouble ticket submitter in the trouble ticket. The trouble ticket may be submitted by a customer user of the data processing systems 160, 170 or 180, by an IT agent managing IT vendor data center 120 or customer data centers 150, by an IT agent managing trouble ticket management system 300 (perhaps when conversing with a user that is describing an IT issue), or it may be submitted automatically by the data process system or specific IT assets as an IT issue is detected by that system or asset. Until the trouble ticket has been resolved and closed, it may be referred to herein as an unresolved trouble ticket.

Optionally, in a second step 505, the unresolved trouble ticket may be automatically assessed for identifying the relevant IT assets and symptom categories by management module 305. This analysis may include reviewing natural language analysis of the description of the IT issue. Based on this analysis, the trouble ticket may be assessed based on factors such as the description of the IT issue, the IT asset or subsystem mentioned in the trouble ticket, the location of the IT asset or subsystem, the identity of the trouble ticket submitter, etc. This automated assessment of relevant IT assets and symptom categories may be stored with or linked to the trouble ticket in trouble ticket database 310.

Then in step 510, the classified trouble ticket may be assigned to an IT agent and recorded as such in the trouble ticket database 310 with a unique identifier of the assigned IT agent. This assignment may be performed automatically by trouble ticket system management module 305 or upon the direction of a person responsible for that assignment task. This assignment may be based on the trouble ticket IT issue, the relevant IT assets, the symptom categories, the experience and capabilities of the IT agent relative to the trouble ticket classification, the availability of the IT agent, etc. Additional IT agents may also be assigned if needed.

In step 515, which may be performed prior to or concurrent with step 510 or step 520, an IT issue prediction for the trouble ticket may be obtained by comparing or otherwise submitting that trouble ticket to implemented trouble ticket model 385. Implemented trouble ticket model may provide an issue prediction to the trouble ticket for storage in trouble ticket database 310 indexed to the trouble ticket. This issue prediction may include a predicted issue type and a predicted root cause identified from a predefined set of issue type and root cause classifications, which may be hierarchically organized, and other information regarding prior trouble tickets that addressed the same or similar IT issue. In an alternative embodiment, multiple implemented trouble ticket models may be utilized with the classification of the trouble ticket being utilized to determine which model to use. The process of providing this issue prediction is described below in greater detail.

In step 520, the assigned IT agent may then open the unresolved trouble ticket from trouble ticket database 310 for determining the issue type and root cause of the IT issue described in that ticket towards providing any necessary remediation for resolving the open trouble ticket. Concurrently with and responsive to the assigned IT agent opening the trouble ticket and until the IT agent’s trouble ticket on-line session has ended or until the trouble ticket is closed, session event generator 360 may monitor the actions of the IT agent with regards to the open trouble ticket in step 525. Additional monitoring of the actions of the IT agent may be performed when the IT agent utilizes a log viewer or other IT tool. This monitoring may include generating session events (such as shown in FIG. 4) that identify the actions taken by the IT agent with regards to the trouble ticket as well as identifying the various types of information accessed by the IT agent. These session events may be automatically stored in a session event database 330 for utilization later as explained below. In alternative embodiments, this monitoring may be by IT agent on-line session or by IT tool, depending on the type and breadth of session event generators available.

Then in step 530, the assigned IT agent may review the IT issue prediction from implemented trouble ticket model 385, if provided. As described below, there may not be an issue prediction provided until a sufficient number of similar trouble tickets have been processed. In step 535, the IT agent may then investigate the trouble ticket issue by utilizing log viewer 355, telemetry viewer 356 and other IT tools from set of IT tools 350 to access and review log files from log file database 320, telemetry from telemetry database 325, and other accessible data of IT assets that may be relevant to the IT issue (e.g., IT assets and symptoms) described in the assigned trouble ticket. This investigation process may be driven in part by the issue prediction, if provided. This process may enable the IT agent to determine or confirm an issue type and root cause of the assigned trouble ticket.

In step 540, upon determining or confirming the issue type and root cause, the IT agent may determine an appropriate resolution, including any needed remediation, of the IT issue. In step 542, the IT agent may implement or cause to be implemented the appropriate remediation to resolve the determined issue type and root cause. This may be implemented after performing some tests to confirm that the remediation solves the issue type and root cause and does not create new IT issues. Then in step 544, the IT agent may confirm that the remediation resolves the IT issue and may confirm that the remediation does not create new IT issues. Then in step 546, the IT agent may then document the identified issue type and root cause as well as the remediation steps in the trouble ticket. In step 548, the IT agent closes the trouble ticket in trouble ticket database 310 and monitoring by session event generator 360 may cease.

As will be apparent to those of ordinary skill in the art, multiple IT agents may be assigned to a trouble ticket and each IT agent may utilize multiple on-line sessions to investigate, diagnose and resolve the trouble ticket. Each such on-line session may be monitored and documented by session event generator 360 for generating session events which can be linked or otherwise associated with a specific trouble ticket. Once one or more trouble tickets have been closed, processing may then continue to the steps described below with reference to FIG. 5B.

As mentioned above, FIG. 5B provides a flow diagram 550 of utilizing previously processed trouble tickets to develop an implemented trouble ticket model 385 which may then be utilized to provide an automated issue prediction of a trouble ticket. The session event aggregation steps described below may be performed during the trouble ticket resolution process of FIG. 5A, upon the closing of each trouble ticket, periodically as batches of trouble tickets, or at any other time desired by the IT vendor towards developing a trouble ticket modelling system. The present embodiment is described as aggregating the session events for one or more trouble tickets upon the closing of those trouble tickets. This aggregation is described in the present embodiment as an initial aggregation of session events and log data lines by trouble ticket followed by a secondary aggregation of the same by other factors. By organizing the session events and log data lines by trouble ticket, it may be easier to associate an event type and root cause with each such type of data. In addition, if all session events were stored in memory with an associated trouble ticket, then the initial aggregation may not be as useful for organizing the session events and log data lines for further aggregation and utilization as described herein.

In step 554, the session events for the trouble ticket may be initially and automatically aggregated in chronological order by session event aggregator 365 for storage in aggregated session event database 335. That is, session events may be automatically grouped together by trouble ticket organized in chronological order therein. For example, multiple IT agents may work on a trouble ticket across multiple sessions utilizing multiple tools, thereby generating session events stored across multiple files and/or tables. By aggregating session events chronologically by trouble ticket, the analysis utilized by the IT agent for each trouble ticket may be more easily utilized such as automatically through modeling. In addition, aggregating session events may also allow for easier labeling for use in modeling the trouble ticket process. This session event aggregation may utilize various data types of each session event to discern which trouble ticket was being processed during that session event. For example, a combination of timestamp, session ID and user ID (identifying the IT agent) may be utilized to identify the associated trouble ticket.

In step 558, any log data lines from log files, telemetry, etc. that was accessed and viewed by the IT agent is also associated and aggregated with the session events in chronological order by session event aggregator 365. When performing later analysis of an IT agent’s processing of a given trouble ticket, both the actions taken (e.g., session events) and the log data lines accessed and utilized by those actions may be useful in recognizing how a root cause was determined and which remediation steps are need to resolve the trouble ticket. Step 558 may be performed concurrently with step 554. Then in step 562, the aggregated session events and associated accessed log data lines may be stored in aggregated session event database 335 by management module 305 for ease of access and use. Alternatively, a pointer file indexing the session events and associated data may be utilized instead. Step 562 may also be performed concurrently with steps 554 and 558. Then in step 566, a secondary aggregation may be performed by session event aggregator 365 in accordance with predetermined criteria 342. This secondary aggregation may include cross-correlating session events and associated log data lines by issue type, root cause, IT agent ID (also referred to herein as user ID), asset ID or groups of asset IDs, etc. This secondary aggregation may be documented in aggregated session event database 335 as cross-links between the cross-correlated session events and associated log data lines. In alternative embodiments, the session events and associated log data lines may be aggregated in a single aggregation step. Steps 554 through 566 may be viewed as pre-processing steps for filtering and labeling as described with reference to the present embodiment in the following steps.

In step 570, the log data lines in aggregated session event database 335 may be filtered by label generator 370 and indicated as passing or not passing this filtration in aggregated session event database 335. This filtration of log data lines may be based on the set of predetermined criteria 342 in anticipation of or concurrently with labeling and storing the filtered log data lines in label database 340. This filtering of log data lines may include selecting log data lines that were viewed or otherwise accessed by an IT agent such as through a keyword search, a copy and paste operation, the last viewed log data lines accessed prior to closing a trouble ticket, log data lines that were in common with log data lines accessed during investigation of other trouble tickets with the same symptoms, issue type or root cause, and other predetermined log data lines as may be identified in predefined criteria 342. For example, statistical analysis or machine learning may also be utilized to identify other possible criteria for filtering log data lines.

In step 575, a label data item, also referred to herein as a label record, may be generated by label generator 370 and stored in label database 340 for each session event that is associated with a filtered log data line that passed filtering step 570. These label data items stored in label database 340 may be utilized in modeling as described below. Each label data item may include the log data lines associated with the session event, even if not all of those log data lines passed the filtration process described above. Each label data item may include information from the session event and trouble ticket associated with that session event such as event type, root cause, IT agent ID, timing information, remediation, etc. Each label data item may further include information regarding correlated session events and log data lines including pointers thereto. Each label data item may also include information regarding the type of filtration (e.g., predetermined criteria 342) that the associated log data line(s) passed. If a session event is not associated with any log data lines or log data lines that passed filtration, that session event may not be utilized for generating a label data item. This reduces the number of session events that are not associated with actual data values found in log data lines. In an alternative embodiment, such session events may be labeled and included in label database 340. In another alternative embodiment, the label data items may be stored as labels and pointers to session events and log data lines in aggregated session event database 335. As will be apparent to those of ordinary skill in the art, alternative methods of organizing and storing the labeled data may be utilized for preparing the underlying information for modeling as described below.

In step 580, after a sufficient number of trouble tickets have been processed and monitored with the resulting session events and log data lines aggregated and labeled, the label database 342 may be utilized for modeling the trouble ticket process towards identifying commonality between trouble tickets and the underlying IT issues driving those trouble tickets. This labeled information can then be utilized by the model towards predicting the issue as a case classification, including event type and root cause, for a given trouble ticket. That is, in the present embodiment, artificial intelligence such as machine learning may utilize supervised learning with the labeled database to determine the relationship between the inputs (e.g., IT asset type, symptoms, log data lines, etc.) and outputs (e.g., case classification including event type and root cause). These relationships may then be utilized towards identifying which log data lines to inspect for a given IT asset type and symptoms towards predicting the event type and root cause of subsequently submitted trouble tickets. With automated inspection of the identified log data lines of the relevant IT assets, a prediction of the case classification, including event type and root cause, may be completed without human intervention as described below. In alternative embodiments, statistical analysis may be utilized to find correlations among the labelled data sufficient to provide predictions of issues as case classifications, such as event type and root cause, within a predesignated confidence interval and level of confidence. As will be apparent to those of ordinary skill in the art, other types of modeling may be utilized for providing predictions of issues within desired limits and levels of confidence, including the utilization of multiple competing models for comparative analysis. In step 585, the resulting model may be tested for a given period of time against subsequently submitted trouble tickets, including inspection of selected log data lines of relevant IT assets, to confirm that the model has matured sufficiently for implementation in a production environment of an IT system monitoring and management operation. This level of model maturity may be establish by comparing the predictive value of the model against a predetermined threshold.

In step 590, the mature model is utilized for automatic issue prediction in response to a query. That is, the categorized symptoms and IT assets of a submitted trouble ticket may be provided by a query by an IT agent or automatically in response to a submitted trouble ticket for predicting a case classification, including an event type and root cause. Then in step 592, implemented model 385 utilizes the categorized symptoms and IT assets from the query to automatically predict the case classification, including event type and root case, as designed and tested above. Furthermore, implemented model 385 may provide or otherwise identify values from selected log data lines of the set of IT assets suitable for confirming the predicted case classification. These selected log data lines may correspond to log data lines associated with the prior resolved trouble tickets with statistically similar symptoms and corresponding IT assets. Furthermore, implemented model 385 may identify the prior resolved trouble tickets with statistically similar symptoms and corresponding IT assets including identifying remediation steps taken to resolve those trouble tickets. Finally, in step 596, implemented model 385 may automatically investigate the identified values from the selected log data lines of the set of IT assets from step 592, compare those values to the predicted values to confirm the predicted case classification. As will be apparent to those of ordinary skill in the art, alternative implemented models may utilize or provide other predictions and confirmation of those predictions based on other characteristics or previously resolved trouble tickets that have been modeled such as described herein.

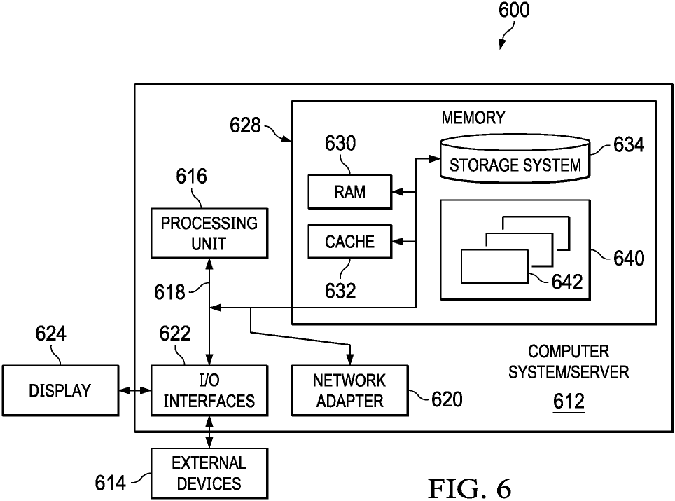

FIG. 6 provides a block diagram of an illustrative data processing system in which various embodiments of the present disclosure may be implemented. Data processing system 600 is one example of a suitable data processing system for managing trouble tickets and is not intended to suggest any limitation as to the scope of use or functionality of the embodiments described herein. Regardless, data processing system 600 is capable of being implemented and/or performing any of the functionality set forth herein such as automatically generating an issue prediction for a trouble ticket in an IT system monitoring and management operation.

In data processing system 600 there is a computer system/server 612, which is operational with numerous other general purpose or special purpose computing system environments, peripherals, or configurations. Examples of well-known computing systems, environments, and/or configurations that may be suitable for use with computer system/server 612 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 612 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 612 may be practiced in distributed computing environments where tasks are performed by remote processing devices that are linked through a communications network. In a distributed computing environment, program modules may be located in both local and remote computer system storage media including memory storage devices. For example, the present invention may be implemented in a cloud computing environment, distributed or otherwise, which may be virtualized such as with the use of a hypervisor managing multiple nodes including virtual processors, virtual memory, etc.

As shown in FIG. 6, computer system/server 612 in data processing system 600 is shown in the form of a general-purpose computing device. The components of computer system/server 612 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 612 typically includes a variety of non-transitory computer system usable media. Such media may be any available media that is accessible by computer system/server 612, and it includes both volatile and non-volatile media, removable and non-removable media.

System memory 628 can include non-transitory computer system readable media in the form of volatile memory, such as random access memory (RAM) 630 and/or cache memory 632. Computer system/server 612 may further include other non-transitory removable/non-removable, volatile/non-volatile computer system storage media. By way of example, storage system 634 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 618 by one or more data media interfaces. Memory 628 may include at least one program product having a set (e.g., at least one) of program modules that are configured to carry out the functions of the embodiments. Memory 628 may also include data that will be processed by a program product.

Program/utility 640, having a set (at least one) of program modules 642, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of the embodiments. For example, a program module may be software for automatically generating an issue prediction for a trouble ticket in an IT system monitoring and management operation.

Computer system/server 612 may also communicate with one or more external devices 614 such as a keyboard, a pointing device, a display 624, etc.; one or more devices that enable a user to interact with computer system/server 612; and/or any devices (e.g., network card, modem, etc.) that enable computer system/server 612 to communicate with one or more other computing devices. Such communication can occur via I/O interfaces 622 through wired connections or wireless connections. Still yet, computer system/server 612 can communicate with one or more networks such as a local area network (LAN), a general wide area network (WAN), and/or a public network (e.g., the Internet) via network adapter 620. As depicted, network adapter 620 communicates with the other components of computer system/server 612 via bus 618. It should be understood that although not shown, other hardware and/or software components could be used in conjunction with computer system/server 612. Examples, include, but are not limited to: microcode, device drivers, tape drives, RAID systems, redundant processing units, data archival storage systems, external disk drive arrays, etc.

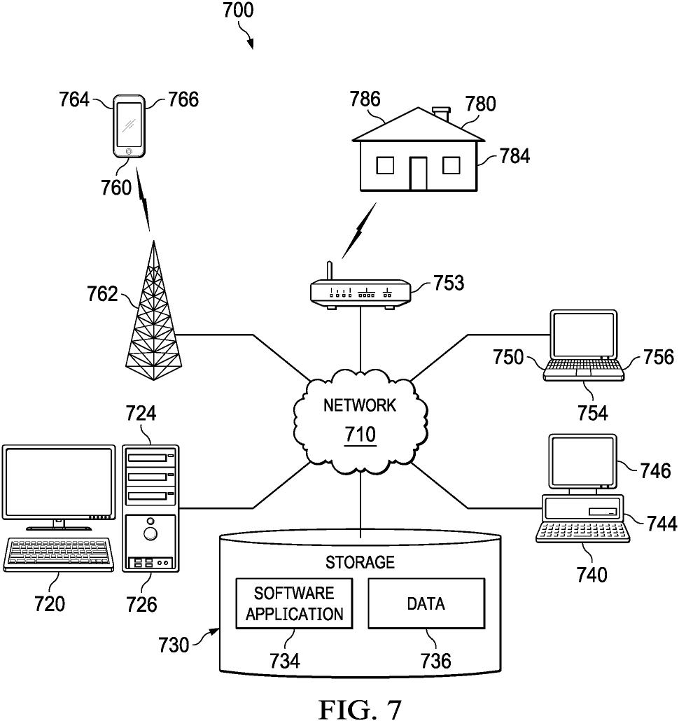

FIG. 7 provides a block diagram of an illustrative network of data processing systems in which various embodiments of the present disclosure may be implemented. Data processing environment 700 is a network of data processing systems such as described above with reference to FIG. 6. Software applications such as for automatically generating an issue prediction for a trouble ticket in an IT system monitoring and management operation may be processed on any computer or other type of data processing system in data processing environment 700. Data processing environment 700 includes network 710. Network 710 is the medium used to provide simplex, half duplex and/or full duplex communications links between various devices and computers connected together within data processing environment 700. Network 710 may include connections such as wire, wireless communication links, or fiber optic cables.

Server 720 and client 740 are coupled to network 710 along with storage unit 730. In addition, laptop 750 and facility 780 (such as a home or business) are coupled to network 710 including wirelessly such as through a network router 753. A mobile device 760 such as a mobile phone may be coupled to network 710 through a cell tower 762. Data processing systems, such as server 720, client 740, laptop 750, mobile device 760 and facility 780 contain data and have software applications including software tools processing thereon. Other types of data processing systems such as personal digital assistants (PDAs), smartphones, tablets and netbooks may be coupled to network 710.

Server 720 may include software application 724 and data 726 for automatically generating an issue prediction for a trouble ticket in an IT system monitoring and management operation or other software applications and data in accordance with embodiments described herein. Storage 730 may contain software application 734 and a content source such as data 736 for automatically generating an issue prediction for a trouble ticket in an IT system monitoring and management operation. Other software and content may be stored on storage 730 for sharing among various computer or other data processing devices. Client 740 may include software application 744 and data 746. Laptop 750 and mobile device 760 may also include software applications 754 and 764 and data 756 and 766. Facility 780 may include software applications 784 and data 786 on local data processing equipment. Other types of data processing systems coupled to network 710 may also include software applications. Software applications could include a web browser, email, or other software application for automatically generating an issue prediction for a trouble ticket in an IT system monitoring and management operation.

Server 720, storage unit 730, client 740, laptop 750, mobile device 760, and facility 780 and other data processing devices may couple to network 710 using wired connections, wireless communication protocols, or other suitable data connectivity. Client 740 may be, for example, a personal computer or a network computer.

In the depicted example, server 720 may provide data, such as boot files, operating system images, and applications to client 740 and laptop 750. Server 720 may be a single computer system or a set of multiple computer systems working together to provide services in a client server environment. Client 740 and laptop 750 may be clients to server 720 in this example. Client 740, laptop 750, mobile device 760 and facility 780 or some combination thereof, may include their own data, boot files, operating system images, and applications. Data processing environment 700 may include additional servers, clients, and other devices that are not shown.

In the depicted example, data processing environment 700 may be the Internet. Network 710 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 700 also may be implemented as a number of different types of networks, such as for example, an intranet, a local area network (LAN), or a wide area network (WAN). FIG. 7 is intended as an example, and not as an architectural limitation for the different illustrative embodiments.

Among other uses, data processing environment 700 may be used for implementing a client server environment in which the embodiments may be implemented. A client server environment enables software applications and data to be distributed across a network such that an application functions by using the interactivity between a client data processing system and a server data processing system. Data processing environment 700 may also employ a service oriented architecture where interoperable software components distributed across a network may be packaged together as coherent business applications.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may be processed entirely on the user’s computer, partly on the user’s computer, as a standalone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for automatically generating an issue prediction for a trouble ticket in an IT system monitoring and management operation. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of automatically providing an issue prediction to an IT (information technology) issue comprising:
receiving a trouble ticket regarding the IT issue, the trouble ticket including information identifying a categorized set of symptoms of the IT issue and identifying a set of IT assets impacted by the symptoms;
utilizing the categorized set of symptoms and identified set of IT assets to query a trouble ticket system model for an automated issue prediction, the issue prediction including a predicted case classification based on case classifications of prior resolved trouble tickets with associated symptoms and IT assets corresponding to the trouble ticket symptoms and IT assets; and
utilizing the predicted case classification to resolve the trouble ticket.

2. The method of claim 1 wherein, responsive to the query, the model also identifies values from selected log data lines of the set of IT assets suitable for confirming the predicted case classification, the selected log data lines corresponding to log data lines associated with the prior resolved trouble tickets and corresponding IT assets.

3. The method of claim 2 further comprising automatically accessing the selected log data lines and comparing the values of the accessed log data lines for automatically confirming the case classification.

4. The method of claim 1 wherein the predicted case classification includes an event type and a root cause corresponding to a previously classified event type and a previously classified root cause of the prior resolved trouble tickets.

5. The method of claim 1 wherein the trouble ticket system model includes a set of labelled session events and associated log lines automatically generated from prior resolved trouble tickets.

6. The method of claim 5 wherein the set of labelled session events and associated log lines include correlations with other session events and associated log lines meeting a set predetermined criteria.

7. The method of claim 6 wherein the set of labelled session events and associated log lines are automatically filtered based on the set of predetermined criteria.

8. The method of claim 7 wherein, responsive to the query, the model automatically identifies selected prior resolved trouble tickets and remediation utilized in those prior resolved trouble tickets.

9. A computer program product for automatically providing an issue prediction to an IT (information technology) issue, the computer program product comprising a computer readable storage medium having program instructions embodied therewith, the program instructions processed by a processing circuit to cause the device to perform a method comprising:
receiving a trouble ticket regarding the IT issue, the trouble ticket including information identifying a categorized set of symptoms of the IT issue and identifying a set of IT assets impacted by the symptoms;
utilizing the categorized set of symptoms and identified set of IT assets to query a trouble ticket system model for an automated issue prediction, the issue prediction including a predicted case classification based on case classifications of prior resolved trouble tickets with associated symptoms and IT assets corresponding to the trouble ticket symptoms and IT assets; and
utilizing the predicted case classification to resolve the trouble ticket.

10. The computer program product of claim 9 wherein, responsive to the query, the model also identifies values from selected log data lines of the set of IT assets suitable for confirming the predicted case classification, the selected log data lines corresponding to log data lines associated with the prior resolved trouble tickets and corresponding IT assets.

11. The computer program product of claim 10 further comprising automatically accessing the selected log data lines and comparing the values of the accessed log data lines for automatically confirming the case classification.

12. The computer program product of claim 9 wherein the trouble ticket system model includes a set of labelled session events and associated log lines automatically generated from prior resolved trouble tickets.

13. The computer program product of claim 12 wherein the set of labelled session events and associated log lines include correlations with other session events and associated log lines meeting a set predetermined criteria.

14. The computer program product of claim 13 wherein the set of labelled session events and associated log lines are automatically filtered based on the set of predetermined criteria.

15. A data processing system for automatically providing an issue prediction to an IT (information technology) issue, the data processing system comprising:
a processor; and
a memory storing program instructions which when processed by the processor perform the steps of:
receiving a trouble ticket regarding the IT issue, the trouble ticket including information identifying a categorized set of symptoms of the IT issue and identifying a set of IT assets impacted by the symptoms;
utilizing the categorized set of symptoms and identified set of IT assets to query a trouble ticket system model for an automated issue prediction, the issue prediction including a predicted case classification based on case classifications of prior resolved trouble tickets with associated symptoms and IT assets corresponding to the trouble ticket symptoms and IT assets; and
utilizing the predicted case classification to resolve the trouble ticket.

16. The data processing system of claim 15 wherein, responsive to the query, the model also identifies values from selected log data lines of the set of IT assets suitable for confirming the predicted case classification, the selected log data lines corresponding to log data lines associated with the prior resolved trouble tickets and corresponding IT assets.

17. The data processing system of claim 16 further comprising automatically accessing the selected log data lines and comparing the values of the accessed log data lines for automatically confirming the case classification.

18. The data processing system of claim 15 wherein the trouble ticket system model includes a set of labelled session events and associated log lines automatically generated from prior resolved trouble tickets.

19. The data processing system of claim 18 wherein the set of labelled session events and associated log lines include correlations with other session events and associated log lines meeting a set predetermined criteria.

20. The data processing system of claim 19 wherein the set of labelled session events and associated log lines are automatically filtered based on the set of predetermined criteria.
